(19) United States
(12) Patent Application Publication
(10) Pub. No.: US 2016/0044519 A1
(43) Pub. Date: Feb. 11, 2016

(54) METHOD AND APPARATUS FOR SUPPORTING MOBILE DEVICE SCREEN REPLICATION IN AUTOMOTIVE ENVIRONMENT USING FLEXIBLE NETWORK CONNECTIVITY

(71) Applicants: GM GLOBAL TECHNOLOGY OPERATIONS LLC, DETROIT, MI (US); GENERAL MOTORS LLC, DETROIT, MI (US)

(72) Inventors: Fan Bai, ANN ARBOR, MI (US); DONALD K. GRIMM, UTICA, MI (US); BO YU, WARREN, MI (US); LAKSHMI V. THANAYANKIZIL, ROCHESTER HILLS, MI (US); DAVID P. POP, GARDEN CITY, MI (US); ROBERT A. HRABAK, WEST BLOOMFIELD, MI (US)

(21) Appl. No.: 14/455,683

(22) Filed: Aug. 8, 2014

(51) Int. Cl. H04W 24/02

(52) U.S. Cl. CPC H04W 24/02

(57) ABSTRACT

A system and method for supporting mobile device connectivity with a vehicle. A mobile device is provided that includes at least one connectivity option for connecting to a communications channel of the vehicle. A flexible connectivity module that includes a controller is programmed to determine if there is at least one matching communication channel between the mobile device and the vehicle such that the mobile device and the vehicle may be in communication with each other. The controller selects the optimal connectivity option if there is more than one of the matching communication channels available and monitors the selected connectivity option and changes or modifies the selected connectivity option if a predetermined interference threshold is achieved.

### BACKGROUND OF THE INVENTION

1. Field of the Invention

This invention relates generally to a system and method for supporting a mobile device using more than one network connectivity option and, more particularly, to a method and apparatus for providing a flexible network connectivity manager that accommodates different types of network connectivity options and that selects a desired connectivity option for one or more mobile devices.

2. Discussion of the Related Art

Cell phones have become increasingly sophisticated in recent years, and are now commonly used for email, internet access, various special-purpose applications, and, of course, their utility as a phone. Cell phones with such capabilities are often referred to as smartphones. Smartphones are typically designed to allow wireless Local Area Network (wireless LAN, also known as WiFi) or other wireless communications to be used for all applications except actual cell phone calls. However, in the absence of WiFi or other wireless communication channels, the cellular communication network is used to deliver data for all applications on demand.

Because of the wealth of applications supported by smartphones, many modern vehicles now support seamless integration of one or more smartphones with the vehicles' infotainment systems. For example, a smartphone could be used to stream music from an internet radio service to be played over a vehicle's audio system, or the smartphone could access an internet-based video-sharing site and display the videos on the vehicle's rear-seat entertainment screen. Many vehicles support integration of smartphones using wireless communication technologies, such as Bluetooth and WiFi, within the vehicle.

Other types of electronic devices are also frequently used in vehicles. Such devices include tablet-type computers and ebook readers, laptop computers, MP3 music players, gaming devices and others. Some of these devices may have cellular communications capability, while others do not. However, many such devices have some sort of wireless communication capability—such as Bluetooth or WiFi—which allow the devices to transfer files and data when network services are available. These devices may also have hardwire-connection data transfer capability, such as a universal serial bus (USB).

While applications such as Apple CarPlay and Android Auto provide a way to use a vehicle display to project the screen of an electronic device in the vehicle, such as a smartphone, there is a need in the art for a way to determine the best connectivity option that is available between the vehicle and the smartphone to ensure the best quality projection possible.

### SUMMARY OF THE INVENTION

In accordance with the teachings of the present invention, a system and method is disclosed for supporting mobile device connectivity with a vehicle. A mobile device is provided that includes at least one connectivity option for connecting to a communications channel of the vehicle. A flexible connectivity module that includes a controller is programmed to determine if there is at least one matching communication channel between the mobile device and the vehicle such that the mobile device and the vehicle may be in communication with each other. The controller selects the optimal connectivity option if there is more than one of the matching communication channels available and monitors the selected connectivity option and changes or modifies the selected connectivity option if a predetermined interference threshold is achieved.

Additional features of the present invention will become apparent from the following description and appended claims, taken in conjunction with the accompanying drawings.

### BRIEF DESCRIPTION OF THE DRAWINGS

FIG. 1 is a block diagram illustration of a vehicle communications module that may be used to facilitate data transfer from an electronic device in a vehicle for screen replication on an in-vehicle infotainment system display;

FIG. 2 is a block diagram illustration of vehicle communications architecture that is able to choose the best communication path to facilitate the data transfer; and

FIG. 3 is a flow diagram of an algorithm for utilizing a connectivity manager that determines the best communication path to facilitate the data transfer to provide optimal screen replication.

### DETAILED DESCRIPTION OF THE EMBODIMENTS

The following discussion of the embodiments of the invention directed to a system and method that determines the best communication path to facilitate data transfer to provide screen projection from an electronic device to a display on a vehicle is merely exemplary in nature, and is in no way intended to limit the invention or its applications or uses. For example, while a vehicle environment is described herein, other environments for screen replication may be used.

As stated above, electronic devices that are capable of being connected to a vehicle's information and entertainment (infotainment system) is known to those skilled in the art, for the sake of simplicity, all electronic devices in the following discussion will be referred to as smartphones, but it is to be understood that the methods and systems described herein are applicable to any suitable electronic device.

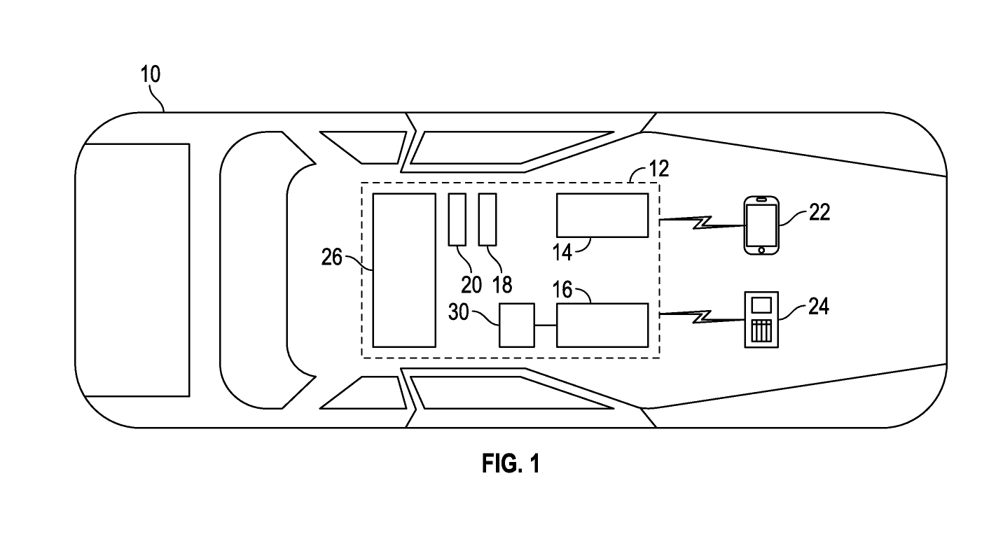

FIG. 1 is a block diagram illustration of a vehicle 10 that includes communications architecture 12 that can be used to replicate a smartphone device screen on a vehicle display 30. The display 30 is intended to represent any display that may be part of an infotainment system of the vehicle 10. The vehicle communications architecture 12 includes a forward audio/video channel 14, a reverse control channel 16 a Transmission Control Protocol/User Datagram Protocol (TCP/UDP) 18, an Internet Protocol (IP) 20 and a flexible connectivity module 26, which are described in detail below. A smartphone 22 is wirelessly connected to the communications architecture 12, and a smartphone 24 is connected to the communications architecture 12 using a wired connection such as a Universal Serial Bus (USB). While the smartphone 24 is connected via a wired connection according to this exemplary embodiment, the smartphone 24 may also connect using a wireless communications link. As is described in detail below, the flexible connectivity module 26 determines the communications links that are available for each phone and utilizes the most desirable communications link that is available.

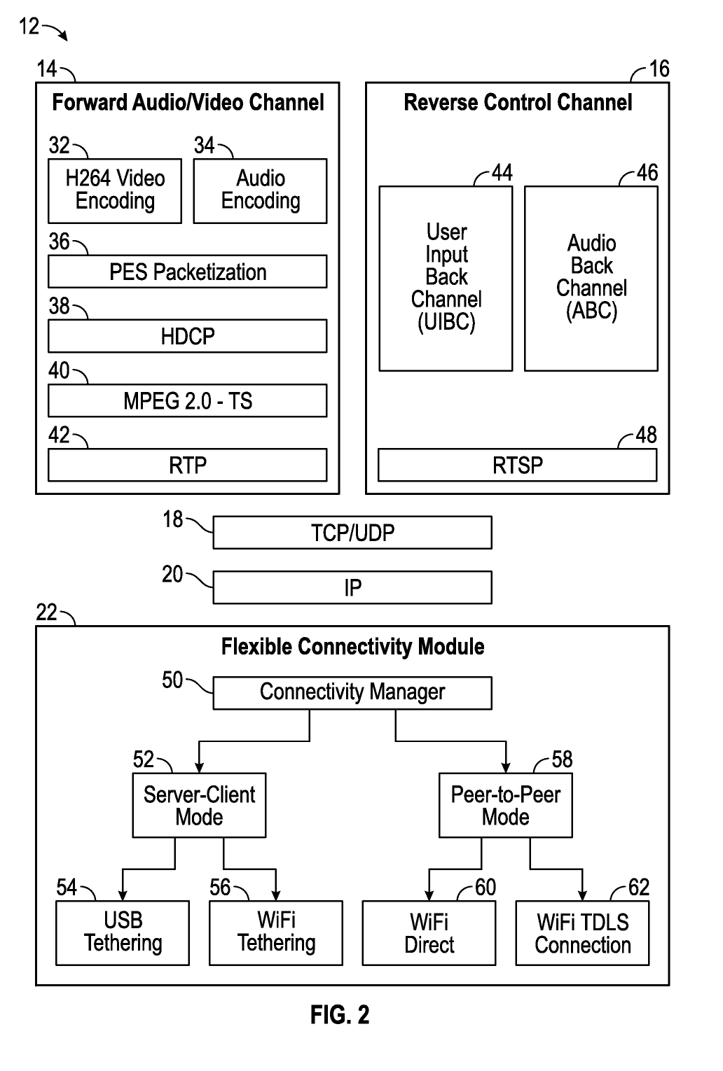

FIG. 2 is an illustration of a block diagram of the vehicle communications architecture 12 in more detail. The forward audio/video channel 14 provides content to a user via the display 30 and includes video encoding at box 32, such as H.264 video encoding. Audio encoding is provided at box 34. The audio is ultimately provided to the user through speakers associated with the display 30, although not shown for the sake of accuracy. Packetized Elementary Stream (PES) packetization at box 36 carries the output of the video encoding at the box 32 and the output of the audio encoding at the box 34 into packets. High-bandwidth Digital Content Protection (HDCP) at box 38 prevents copying of digital audio and video content as it travels across connections. A MPEG 2.0 transport stream at box 40 provides generic coding for transferring picture and associated audio data. A Real-time Transport Protocol (RTP) at box 42 defines a standardized packet format for delivering audio and video from the MPEG 2.0—TS at box 40 to the display 30.

The reverse control channel 16 includes a User Input Back Channel (UIBC) 44 and an Audio Back Channel (ABC) 46 to allow a user to provide commands via, for example, touchscreen events or button push events using the UIBC 44 and/or microphone events using the ABC 46. A Real Time Streaming Protocol (RTSP) at box 48 controls streaming media servers in a manner known to those skilled in the art. The smartphone 22 and/or 24 features from the box 14 as well as user features of the vehicle 10 from the box 16 use a TCP/UDP at box 18 that delivers files from one location to another in a manner known to those skilled in the art, and is a core protocol of the IP at box 20. The flexible connectivity module 26 includes a connectivity manager 50 that determines the best connection to use between an electronic device, such as the smartphone 22 and/or 24, and a vehicle infotainment system that includes a display in the vehicle 10, such as the display 30. When operating in a server-client mode 52, the connectivity manager 50 utilizes USB tethering 54 or a WiFi tethering 56. The USB tethering 54 includes a plug-in communications link that uses a USB connection. The WiFi tethering includes a communication link with one device being used as a router and the other devices connecting thereto.

When the connectivity manager 50 is operating in a peer-to-peer mode 58, the connectivity manager utilizes a WiFi direct connection 60 or a WiFi Tunneled Direct Link Setup (TDLS) connection 62. The WiFi direct connection 60 could also include peer-to-peer negotiated connections such as Bluetooth. The WiFi TDLS connection 62 includes an intermediary connection such as a phone as a hotspot or a vehicle as the hotspot. As is described in more detail below, the connectivity manager 50 determines the most optimal way to utilize the connections 54, 56, 60 and 62. The connections 54, 56, 60 and 62 are merely exemplary in nature, other communications/medium such as WiGig and other wireless communications may be used. Content streams may use, by way of example, the USB tethering 54 and in parallel microphone input or output may use the WiFi direct connection 60. In addition, as is described in more detail below, data streams that are routed by the connectivity manager 50 may be re-routed by the connectivity manager as needed.

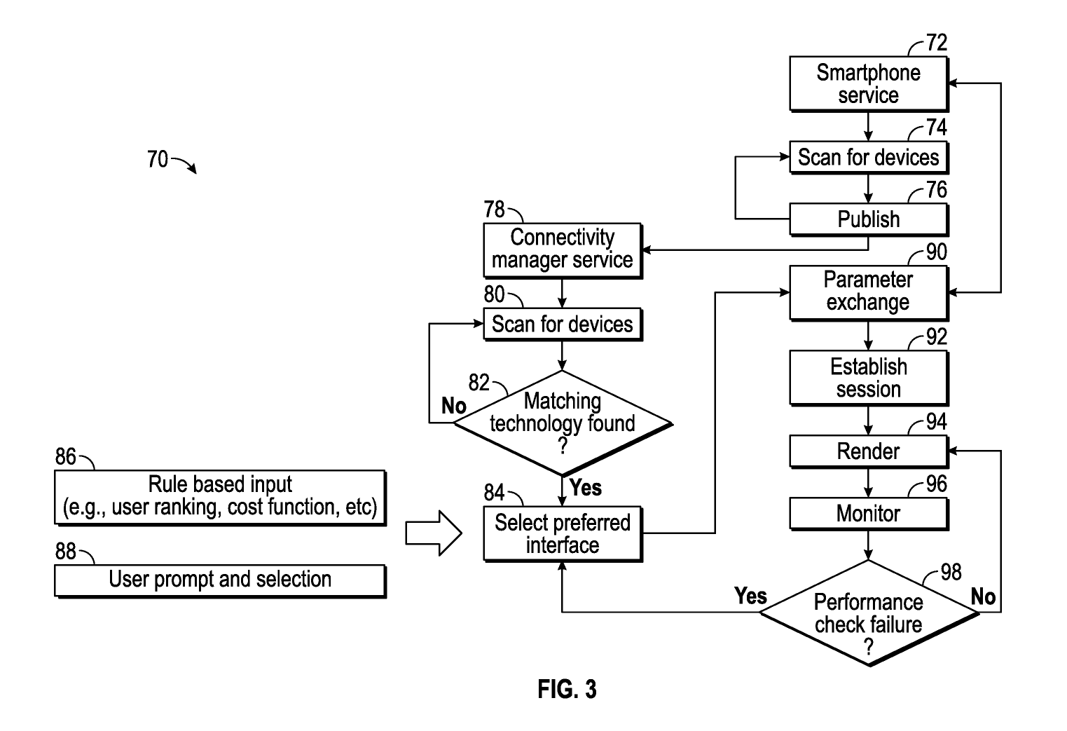

FIG. 3 is a flow diagram 70 of an algorithm for utilizing the connectivity manager 50 to connect electronic devices such as the smartphones 22 and 24 to the vehicle 10 according to one embodiment of the invention. At box 72, smartphone service is provided to a smartphone in the vehicle 10, such as, for example, the smartphone 24. The smartphone 24 scans local connectivity options at box 74 and publishes the available options at box 76. At box 78, the connectivity manager 50 of the flexible connectivity module 22 establishes service to the vehicle 10. The connectivity manager 50 scans local connectivity options on the vehicle 10 and publishes the available options at box 80. Next, the algorithm determines if matching technology between the connectivity options of the vehicle 10 and the connectivity options of the smartphone 24 is available. If matching technology is not found, the algorithm returns to box 80 and the connectivity manager 50 again scans local connectivity options.

If matching technology between the connectivity options of the vehicle 10 and the connectivity options of the smartphone 24 are found at decision diamond 82, the algorithm selects a preferred interface at box 84. In determining what interface is preferred, the algorithm considers rule-based input at box 86 and/or a user selection upon user prompting at box 88. Some examples of rule-based inputs are user ranking, cost function, etc. Any suitable rule-based input may be used.

For example, when the smartphone 24 and the vehicle 10 connectivity options are scanned, the following table may result:

TABLE 1

| | WiFi | WiFi | WiFi | |
|---|---|---|---|---|
| | Direct | TDLS | Tethering | USB |
| Server | ✓(ch11, | | ✓(ch1, | ✓(USB3.0) |
| (Phone) | 12 Mbps) | | AP-WPS) | |
| Client | ✓(ch11, | ✓(ch6, | | ✓(USB2.0) |
| (HU) | 24 Mbps) | AP-WPS, | | |
| | | 6 Mbps) | | |
| Common | ✓ | | | ✓ |
| Availability | | | | |
| Final | ✓(ch11, | | | |
| Choice | 12 Mbps) | | | |

Table 1 shows four different connectivity options (WiFi Direct, WiFi TDLS, WiFi Tethering and USB) are possible, but only two of the possible options are found on both the vehicle 10 and the smartphone 24 (WiFi Direct, USB). In this example, the algorithm takes into consideration rule-based selection and user preference and determines that channel 11 at 24 megabytes using WiFi Direct is the preferred interface. The preferred interface is determined for the data that flows between the vehicle 10 and the smartphone 24, and may vary for different data. For example, audio/video from the smartphone 24 may use USB tethering as the preferred interface, where microphone input may use WiFi Direct at the preferred interface. The algorithm may determine the preferred interface for each of the data boxes 32-42 of the forward audio/video channel at the box 14 and for each of the boxes 44-48 of the reverse control channel at the box 16 to deliver using the most efficient communication path for the data.

Once the preferred interface is selected at the box 84, parameter exchange occurs at box 90 and a session is established at box 92. Once the session is established at the box 92, the screen of the smartphone 24 is projected to the vehicle display 30. The session is monitored at box 96 and the algorithm determines if there is a performance failure at decision diamond 98. If no, the algorithm returns to the box 94 and continues to project the screen of the smartphone 24 to the vehicle display 30. If there is a performance failure, the algorithm returns to the box 84 and selects a new preferred interface. For example, if the smartphone 24 is connected using WiFi Direct as the preferred interface, and a second passenger with a second smartphone 22 enters the vehicle, the WiFi in the smartphone 24 may interfere with the WiFi direct preferred interface between the vehicle 10 and the smartphone 24. If interference occurs that causes a predetermined performance degradation, a performance failure is detected by the algorithm at decision diamond 98 and the preferred interface may be re-selected at the box 84. For example, to correct the interference, WiFi direct may still be used but the chosen operational parameters, for example, frequency range, may be changed to prevent interference between the smartphones 22 and 24. Thus, a new session of the WiFi preferred interface may be created for the smartphone 24 to compensate for the presence of the smartphone 22. Alternatively, the new preferred interface could result in switching from WiFi to USB for the smartphone 24 at the box 84.

Using the algorithm above, high-quality video and screen replication of the smartphone 24 to the display 30 may be achieved using the optimal qualified physical medium, i.e., connection that is available and not simply a user selected connection as is known to those skilled in the art.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for supporting mobile device connectivity with a vehicle, said method comprising:
providing a mobile device that includes at least one connectivity option for connecting to a communications channel of the vehicle;
providing a flexible connectivity module on the vehicle that determines if there is at least one matching communication channel between the mobile device and the vehicle such that the mobile device and the vehicle may be in communication with each other;
providing a connectivity manager that is part of the flexible connectivity module and that selects the optimal connectivity option if there is more than one matching communication channel available; and
monitoring the selected connectivity option and changing or modifying the selected connectivity option if a predetermined interference threshold is achieved.

2. The method according to claim 1 wherein selecting the connectivity option and changing or modifying the selected connectivity option if a predetermined interference threshold is achieved is performed periodically throughout the connection.

3. The method according to claim 1 wherein the connectivity options include USB tethering, WiFi tethering, WiFi direct, WiFi TDLS, WiGig and other wireless medium.

4. The method according to claim 1 wherein modifying the selected connectivity option includes modifying the connection parameters if a predetermined interference threshold is achieved.

5. The method according to claim 1 wherein modifying the selected connectivity option includes changing from one matched communication channel to another matched communication channel if a predetermined interference threshold is achieved.

6. The method according to claim 1 wherein the connectivity manager selects the optimal connectivity option for each data stream that is to be communicated from the mobile device to the vehicle.

7. The method according to claim 6 wherein different data streams may use different connectivity options while concurrently streaming data from the mobile device to the vehicle.

8. A system for supporting mobile device connectivity with a vehicle, said system comprising:
at least one mobile device that includes at least one connectivity option for connecting to a communications channel on the vehicle; and
a flexible connectivity module of the vehicle that includes a controller programmed to determine if there is at least one matching communication channel between the mobile device and the vehicle such that the mobile device and the vehicle may be in communication with each other, said controller further programmed to select the optimal connectivity option if there is more than one of the matching communication channels available, and to monitor the selected connectivity option and change or modify the selected connectivity option if a predetermined interference threshold is achieved.

9. The system according to claim 8 wherein the selection of the optimal connectivity option includes rule-based inputs, user selection, or a combination thereof.

10. The method according to claim 8 wherein the connectivity options include USB tethering, WiFi tethering, WiFi direct, WiFi TDLS, WiGig and other wireless medium.

11. The method according to claim 8 wherein modifying the selected connectivity option includes modifying the connection parameters if a predetermined interference threshold is achieved.

12. The method according to claim 8 wherein modifying the selected connectivity option includes changing from one matched communication channel to another matched communication channel if a predetermined interference threshold is achieved.

13. The method according to claim 8 wherein the controller determines the optimal connectivity option for each data stream that is to be communicated from the mobile device to the vehicle.

14. The method according to claim 13 wherein different data streams may use different connectivity options while concurrently streaming data that is being communicated from the mobile device to the vehicle.

15. A method for supporting mobile device connectivity with a vehicle, said method comprising:
providing a mobile device that includes at least one connectivity option for connecting to a communications channel on the vehicle;
providing more than one communications channel on the vehicle;
providing a flexible connectivity module on the vehicle that determines if there is at least one matching communication channel between the mobile device and the vehicle such that the mobile device and the vehicle may be in communication with each other;
comparing the matching communication channels available and selecting the optimal connectivity option if there is more than one matching communication channel that is available to allow screen replication of the mobile device on a display of the vehicle; and
monitoring the selected connectivity option and changing or modifying the selected connectivity option if a predetermined interference threshold of the screen replication is achieved.

16. The method according to claim 15 wherein selecting the optimal connectivity option includes rule-based inputs, user selection, or a combination thereof.

17. The method according to claim 15 wherein the connectivity options include USB tethering, WiFi tethering, WiFi direct, WiFi TDLS, WiGig and other wireless medium.

18. The method according to claim 15 wherein modifying the selected connectivity option includes modifying the connection parameters if a predetermined interference threshold is achieved, changing from one matched communication channel to another matched communication channel if a predetermined interference threshold is achieved, or a combination thereof.

19. The method according to claim 15 wherein the connectivity manager selects the optimal connectivity option for each data stream that is to be communicated from the mobile device to the vehicle.

20. The method according to claim 19 wherein different data streams may use different connectivity options while concurrently streaming data from the mobile device to the vehicle.
